(19) United States
(12) Patent Application Publication
(10) Pub. No.: US 2021/0309322 A1
(43) Pub. Date: Oct. 7, 2021

(54) Rotational Boat Hook and Line Threading Device

(71) Applicant: Luc Jospeh Cote, Toronto (CA)

(72) Inventor: Luc Jospeh Cote, Toronto (CA)

(21) Appl. No.: 16/032,520

(22) Filed: Jul. 11, 2018

(51) Int. Cl. B63B 21/54; F16G 11/14; B63B 21/04

(52) U.S. Cl. CPC B63B 21/54; B63B 21/04; F16G 11/143

(57) ABSTRACT

Here is disclosed a boat hook mooring tool for grasping a rope on a flat deck. The boat hook consists of an elongated handle having a long axis, and opposite first and second ends with a head co-axially mounted to the elongated handle at the first end. The head has a hook which extends away from the head and is positioned perpendicularly relative to the long axis of the handle such that the rope can be captured by the hook by rotating the handle.

### CROSS REFERENCE TO RELATED APPLICATION

This application claims priority from provisional patent application Ser. No. 62/531,135 filed Jul. 11, 2017 and entitled Rotational Boat Hook and Rope Threading Device, the entirety of which is incorporated herein by reference.

### FIELD OF THE INVENTION

The invention relates generally to devices for hooking mooring lines and the like.

### BACKGROUND OF THE INVENTION

When a boat is to be moored, timely and accurate manipulation of mooring lines is necessary, and must often be done out of arm's length reach. Lines may be left on the dock and have to be picked up remotely as the boat approaches, or alternately, lines may be manipulated into position and attached to the dock or mooring from the boat. In either scenario, it is necessary for a person to negotiate the space between a moving boat and dock (or mooring) unless a tool is used to aid in overcoming any distance greater than arm's length.

### DESCRIPTION OF PRIOR ART

Traditional boat hooks consist of a hook shape who's curvature is parallel with the reaching pole. This necessitates a push or pull motion in order to pick up a line. This hook alignment also creates difficulty in picking up a line which is laying on a flat surface. A number of devices are capable of passing a line through and/or around a mooring ring or pole. WO2017086860A1 “Threading device for threading a line or a cable” uses a pulley system to rotate a ring and shackle through a gap or around an object. The “Happy Hooker” mooring tool threads a line through a loop by using a dual cam action leader.

### SUMMARY OF THE INVENTION

In accordance with one aspect of the present invention, there is provided a boat hook for grasping a rope on a flat deck. The boat hook consists of an elongated handle having a long axis, and opposite first and second ends with a head co-axially mounted to the elongated handle at the first end. The head has a hook which extends away from the head and is positioned perpendicularly relative to the long axis of the handle such that the rope can be captured by the hook by rotating the handle.

In accordance with another aspect of the present invention, there is provided a-boat hook tool for grasping a rope. The boat hook consists of an elongated handle having a long axis, and opposite first and second ends with a head co-axially mounted to the elongated handle at the first end. The head has a hook which extends away from the head and is positioned perpendicularly relative to the long axis of the handle such that the rope can be captured by the hook by rotating the handle. The boat hook tool further includes a first elongated chord formed as a loop having opposite first and second ends, the first and second ends of the first elongated chord having connector elements configured to releasably mount to first and second mounting elements formed on the head. The mounting elements on the head and the connector elements on the elongated chord configured to position the loop to extend away from the head parallel to the long axis of the elongated handle.

In accordance with another aspect of the present invention, there is provided a boat hook tool for grasping a rope. The boat hook consists of an elongated handle having a long axis, and opposite first and second ends with a head co-axially mounted to the elongated handle at the first end. The head has a hook which extends away from the head and is positioned perpendicularly relative to the long axis of the handle such that the rope can be captured by the hook by rotating the handle. The boat hook tool further includes an elongated arm mounted to the elongated handle adjacent the head by a clip, the clip positioning the elongated arm to extend away from but parallel to the elongated handle. The elongated arm has a distal end configured to releasably retain a looped end of a second chord, the distal end of the elongated arm further configured to position the looped end in alignment with the hook such that the hook can thread into the looped end when the head is rotated relative to the elongated arm. The clip is configured to permit the arm to rotate relative to the elongated handle.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a perspective view of a boat hook made in accordance with the present invention showing the head portion unscrewed from the elongated handle portion.

FIG. 2 is a front view of the head portion shown in FIG. 1.

FIG. 3 is a perspective taken from the rear of the head portion shown in FIG. 1.

FIG. 4 is a top view of the head portion shown in FIG. 1.

FIG. 5 is a side view of the head portion shown in FIG. 1.

FIG. 6 is a front view of the head portion shown in FIG. 1 showing a circle created by rotating the head along its axis.

FIG. 7 is a perspective view of the boat hook shown in FIG. 1 being used to capture a deck rope.

FIG. 8 is a perspective view of the boat hook shown in FIG. 1 hooking a deck rope.

FIG. 9 is a perspective of the boat hook shown in FIG. 1 picking up a deck rope after hooking it.

FIG. 10 is a perspective view of the boat hook shown in FIG. 1 with an extension loop.

FIG. 11 is a perspective view of the boat hook shown in FIG. 10 with the extension loop attached.

FIG. 12 is a perspective view of the boat hook shown in FIG. 1 with an attachment arm mounted thereto.

FIG. 13 is a perspective view of the boat hook shown in FIG. 12 with a looped mooring line mounted thereto.

FIG. 14 is a perspective view of the attachment arm shown in FIG. 12.

FIG. 15a is a perspective view of the boat hook and mooring line shown in FIG. 13 showing the boat hook engaging a mooring post.

FIG. 15b is a perspective view of the boat hook and mooring line shown in FIG. 13 showing the hook portion engaging the looped mooring line.

FIG. 15c is a perspective view of the boat hook and mooring line shown in FIG. 13 showing the hook portion threading the looped mooring line.

FIG. 15d is a perspective view of the boat hook and mooring line shown in FIG. 13 showing the mooring line being looped onto the mooring post.

FIG. 15e is a perspective view of the boat hook and mooring line shown in FIG. 13 showing the boat hook pulling away from the mooring post with the mooring line attached thereto.

In the drawings like characters of reference indicate corresponding parts in the different figures.

### DETAILED DESCRIPTION OF THE INVENTION

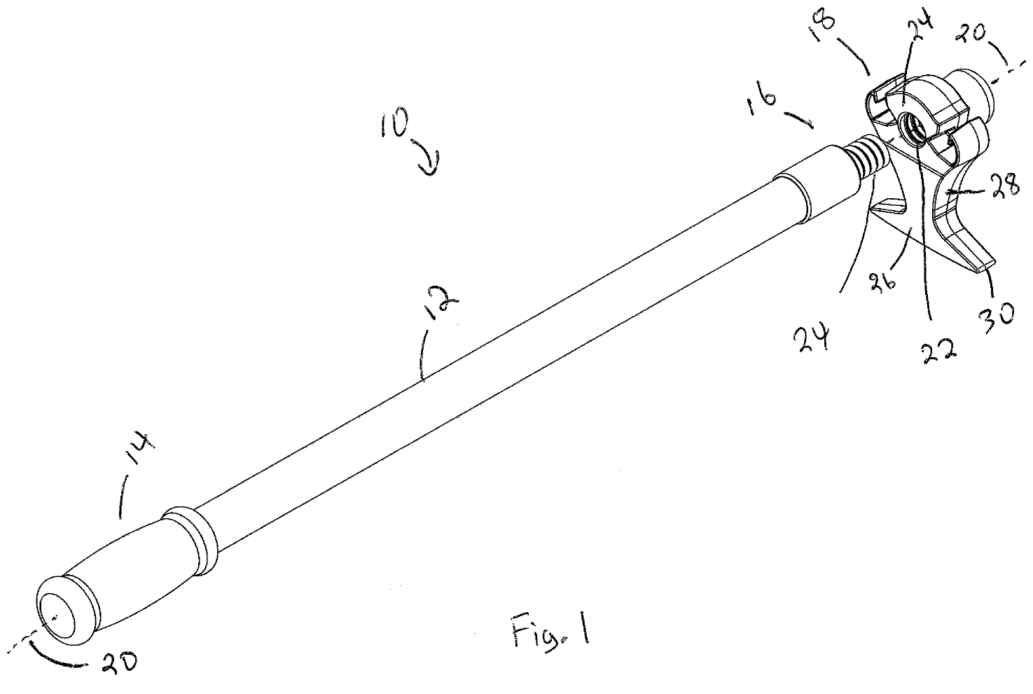

Referring to FIG. 1, a boat hook grasping tool for assisting in mooring boats is shown generally as item 10 and consists of an elongated handle or pole 12 having opposite ends 14 and 16. End 14 is formed as a handle to permit the pole to be grasped comfortably. Elongated handle/pole 12 has long axis 20. Head 18 is co-axially mounted on end 16 of pole 12 preferably by means of a screw hole 22 formed in head 18 which is configured to mate with screw end 24 on pole 12. Pole 12 can be a standard pole having a threaded end and may comprise a single unitary pole or an extendable telescoping pole. When head 18 is screwed onto end 16 of pole 12, the pole and head act as one device so that rotating pole 12 about axis 20 causes head 18 to rotate as well. Head 18 has a hook 26 depending from a body portion 24 by stem 28. As can be seen from FIG. 1, hook portion 26 has tips 30 and hook portion 26 is oriented perpendicularly relative to axis 20 such that rotating pole 12 about axis 20 causes tip 30 to rotate about axis 20 in a circular path.

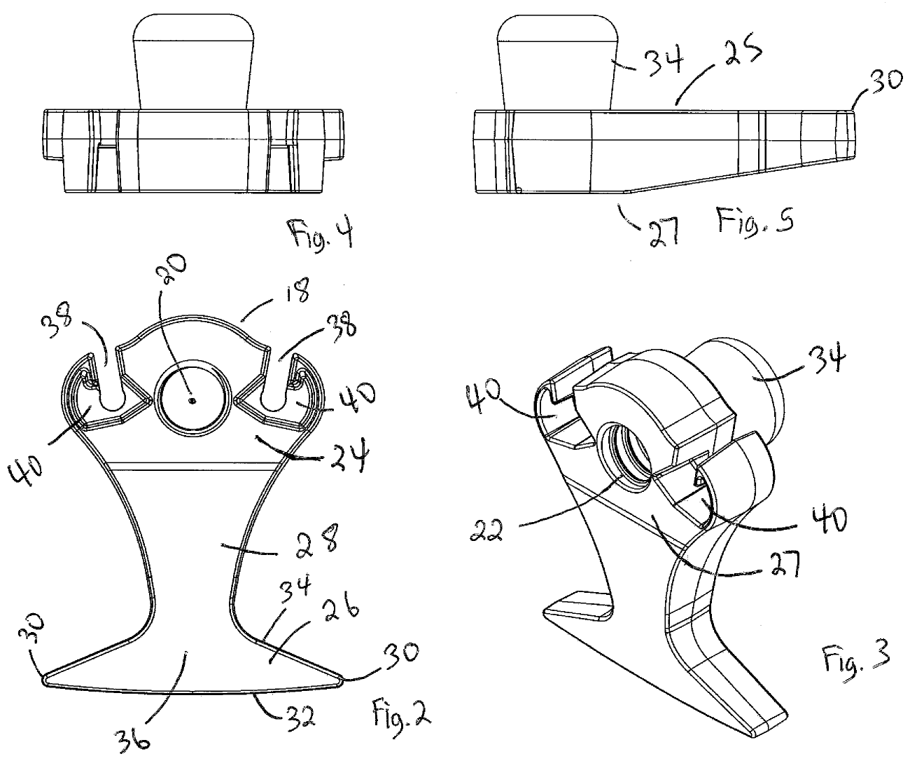

Referring now to FIGS. 2, 3, 4 and 5, head portion 18 preferably comprises a single piece made from injection molded plastic. The head portion has a central body portion 24 having screw hole 22. Hook portion 26 is positioned away from body portion 24 by stem portion 28. A rubber stopper 34 is mounted to the head at side 25 of body portion 24 while the pole (see figure one) attaches on opposite side 27 of the body portion. Preferably rubber stopper 34 is co-axially aligned with screw hole 22. Rubber stopper can be used to push against objects such as docks, buoys or other water craft. Hook portion 26 has hook tips 30 extending from central portion 36 of the hook. Hook portion 26 has curved face 32 which is positioned away from body portion 24 and extend between tips 30. Straight face 34 is formed between tips 30 and stem 28 on the side of hook 26 opposite curved face 32. Preferably straight face 34 is substantially flat and straight between tips 30 and stem 28. As mentioned above, hook portion 26 is positioned perpendicularly relative to axis 20, Slots (notches) 38 are formed on body 24 of head 18 opposite hook portion 26. Cavities 40 are formed on side 27 of body portion 24 adjacent slots 38.

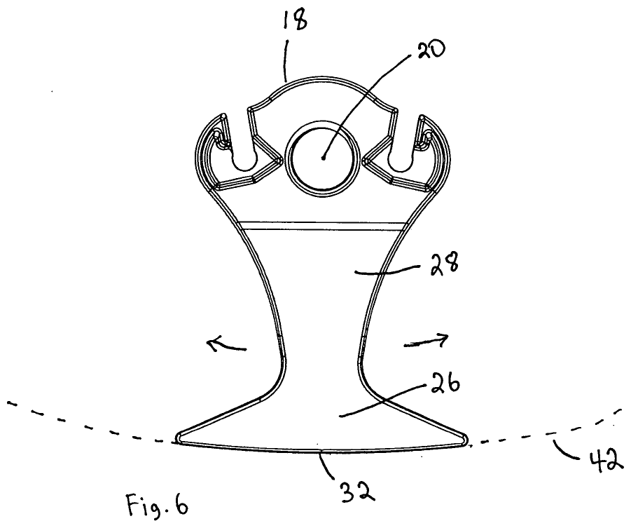

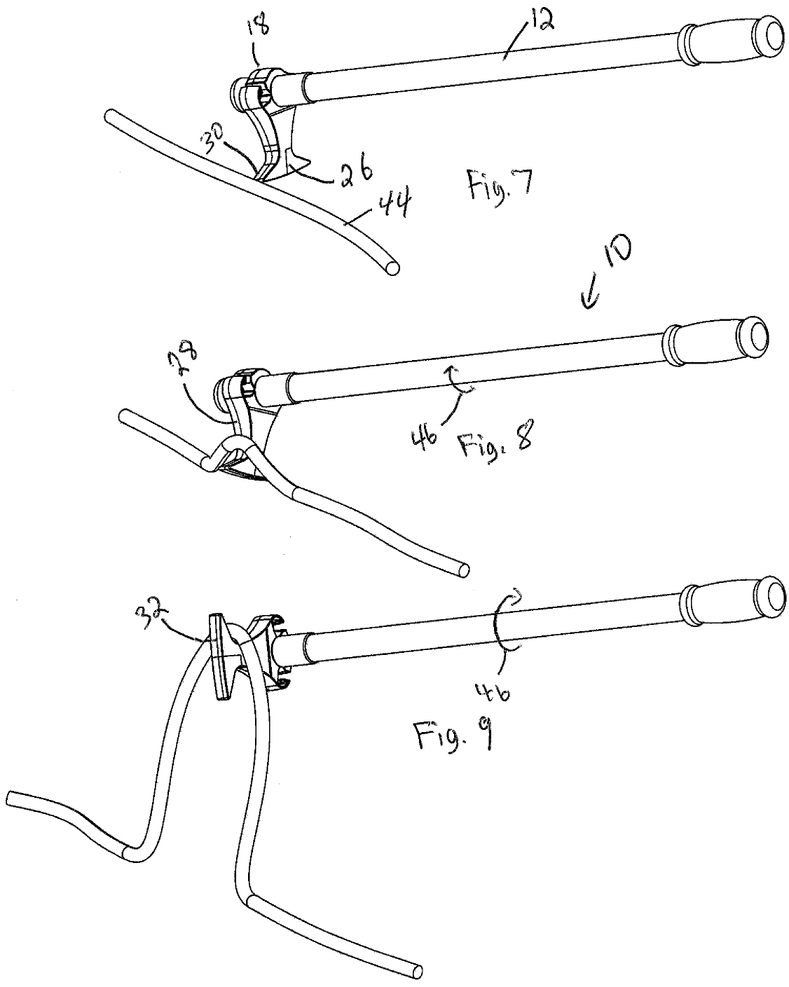

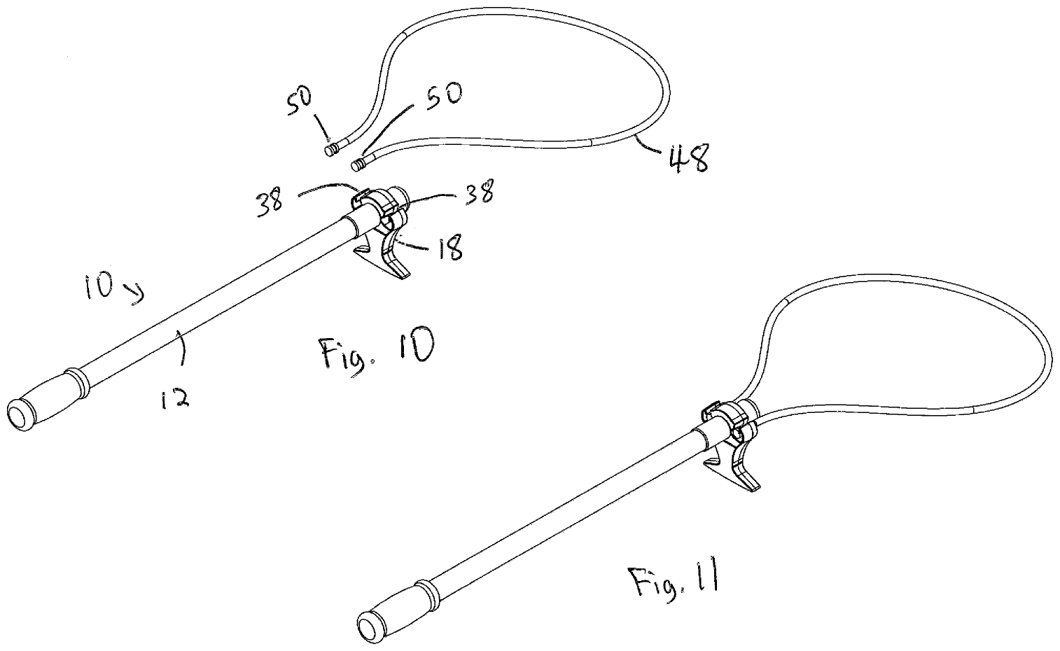

Referring now to FIG. 6, hook portion 26 is positioned perpendicularly relative to axis 20 and is held away from body portion 24 by stem 28. Arched (curved) surface 32 is curved such that it conforms approximately to the curvature of a circumference 42 caused by the rotation of head 18 about axis 20. While the hook of the present invention will work if surface 32 is flat and not curved, a curved face makes the operation of the device easier to use as shall now be described with reference to FIGS. 7, 8 and 9. To use device 10 to pick up a rope 44 lying on a flat surface such as a deck, pole 12 is maneuvered so that head 18 is adjacent the rope and tip 30 contacts the rope as shown in FIG. 7. Pole 12 is then rotated in the direction indicated by arrow 46 which causes the rope to be picked up by the hook as illustrated in FIG. 8 and continued rotation causes the rope to be positioned on stem 28 as shown in FIG. 9. In this way, the user can grasp rope 44 with a simple rotational motion of pole 12 without having to pull the hook back. Curved face 32 helps prevent the hook from hanging up on the deck (not shown) where the rope is resting and also makes it easier to rotate the head in the required direction. Referring now to FIGS. 10 and 11, the boat hook device 10 can be used as a general purpose mooring tool by allowing the device to act as a lasso type of mooring tool by attaching a relatively stiff chord 48 to head portion 18. Stiff chord 48 can be a relatively stiff rope or wire cable which when formed into a loop as illustrated in FIGS. 10 and 11, will substantially keep it's shape as an open loop. The ends of chord 48 is provided with an attachment means, or nubs 50 which are dimensioned and configured to mate with corresponding mounting elements formed on head 18. In this case, the mounting elements on head 18 consist of slots 38 which are dimensioned to receive and hold nubs 50. With chord 48 mounted to head 18 as illustrated in FIG. 11, the tool can be used to grasp mooring poles or other objects as may be required.

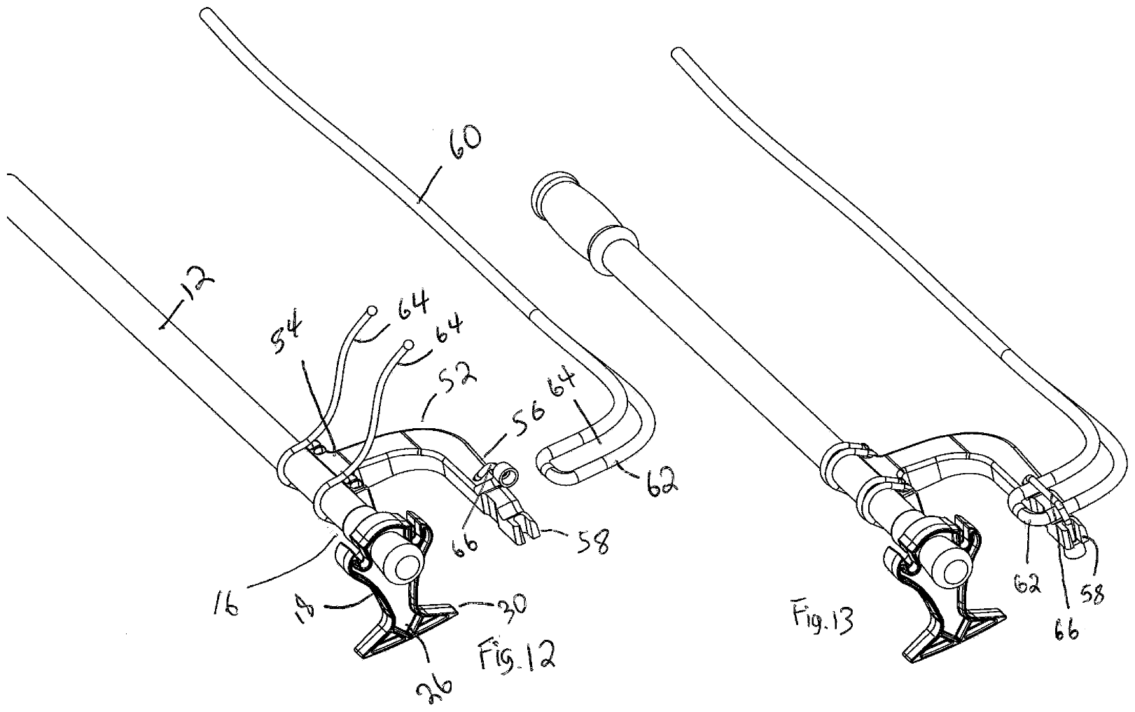

Referring now to FIGS. 12 and 13, the mooring hook made in accordance with the present invention can further be utilized as a moor versatile mooring tool with the addition of a movable arm 52. Movable arm 52 consists of an elongated arm 56 which is mounted to pole 12 at end 16 by a clip portion 54 which positions elongated arm 56 away from and parallel to pole 12. Arm 56 has a tip 58 which is configured to hold a looped end 62 of chord 60 and orient the looped end such that loop aperture 64 is aligned with tip 30 of hook 26. Clip 54 mounts arm 56 such that the arm can rotate relative to pole 12. Preferably, there is some resistance to rotation of the arm about the pole so that the arm is not loosely rotating on the arm. As better seen in FIG. 14, clip 54 is provided with elongated elastic bands 64 which are configured to wrap around the end of the pole and fit into notches 68 to be held in place. By controlling how tightly elastic chords 64 are wrapped onto the end of the pole, the clip can be made to rotate relative to the pole with some resistance. Tip 58 is provided with a notch 72 which is dimensioned and configured to retaine elastic chord 66 and end 70 thereof. Elastic chord 66 helps to hold looped end 62 of chord 60 (see FIG. 13).

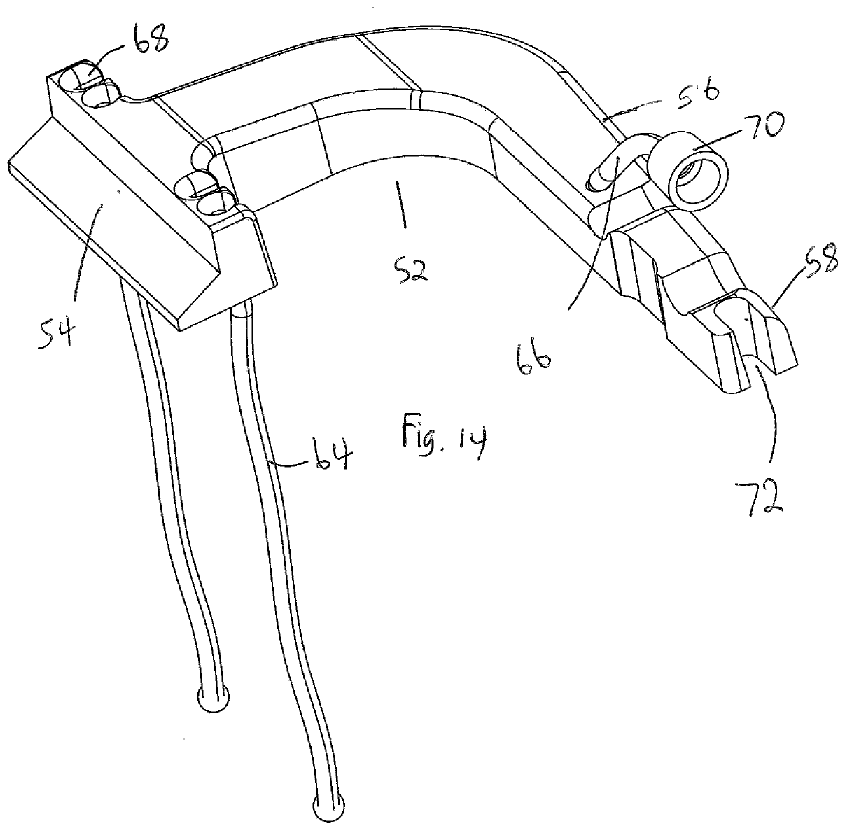

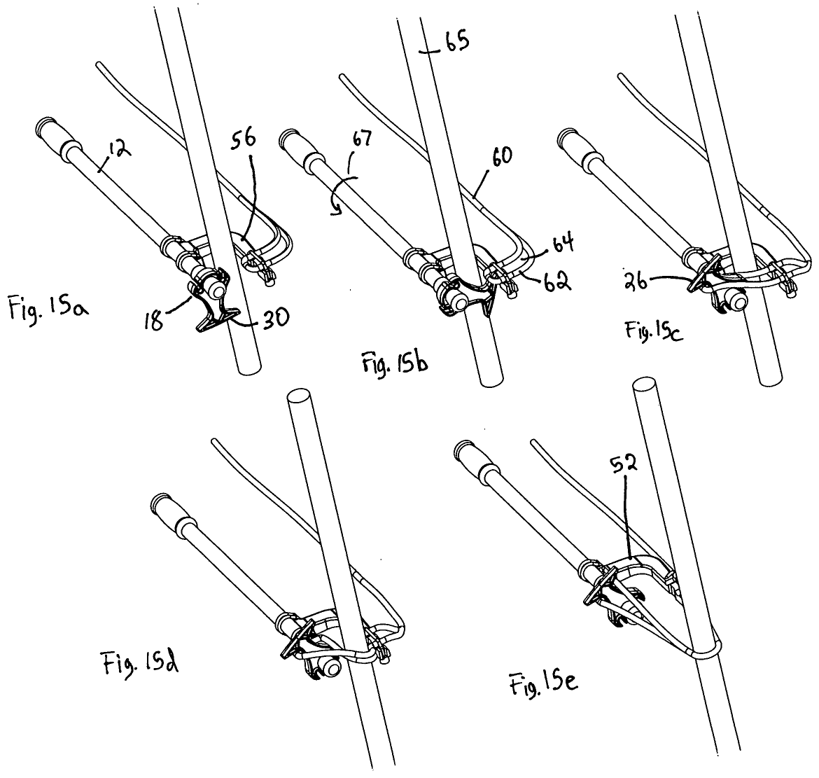

Referring now to FIGS. 15a through 15e, the operation of the mooring hook as a more versatile mooring tool shall now be disclosed. With arm 52 mounted to the end of pole 12 and rope 60 mounted to the end of arm 56, the user pushes the tool towards mooring pole 65 such that the mooring pole is positioned behind head portion 18 and between pole 12 and arm 56 as shown in FIG. 15a. The user then rotates pole 12 in the direction indicated by arrow 67 so that tip 30 of the hook formed on head 18 engages loop 62 and is threaded into opening 64 of the loop as shown in FIG. 15b. As the pole is rotated, aim 56 will remain stationary as its movement is restricted by pole 65; however, since the arm is rotatably mounted to pole 12, head 18 can rotate relative to arm 56. Rotation of the pole continues until hook 26 has grasped loop 62 as shown in FIG. 15c. The user can then pull back on pole 12 so that the rope 60 deploys around mooring pole 65 as shown in FIGS. 15d and 15e. In this way the tool assists the user in looping cord 60 around mooring pole 65. Or course, mooring pole 65 can be any elongated object positioned either vertically or horizontally such as a pole or tensioned cable.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A boat hook for grasping a rope on a flat deck, the boat hook comprising an elongated handle having a long axis, and opposite first and second ends with a head co-axially mounted to the elongated handle at the first end, the head having a hook extending away from the head and positioned perpendicularly relative to the long axis of the handle.

2. The boat hook of claim 1 wherein the hook has a distal end positioned away from the head by a stem extending from the head, the distal end being elongated and extending perpendicularly relative to the long axis of the handle.

3. The boat hook of claim 2 wherein the distal end of the hook has a curved face extending away from the head, the curved face having a curvature approximately equivalent to a circumference of a circle created by rotating the head about the long axis of the handle.

4. The boat hook of claim 3 wherein the distal end of the hook has a straight face opposite the curved face, the straight face extending between the stem and a tip of the hook.

5. The boat hook of claim 1 further comprising a first elongated chord formed as a loop having opposite first and second ends, the first and second ends of the first elongated chord having connector elements configured to releasably mount to first and second mounting elements formed on the head, the mounting elements on the head and the connector elements on the elongated chord configured to position the loop to extend away from the head parallel to the long axis of the elongated handle.

6. The boat hook of claim 5 wherein the connector elements comprise nubs and wherein the mounting elements comprise slots configured to retain the nubs.

7. The boat hook of claim 1 further comprising an elongated arm mounted to the elongated handle adjacent the head by a clip, the clip positioning the elongated arm to extend away from but parallel to the elongated handle, the elongated arm having a distal end configured to releasably retain a looped end of a second chord, the distal end of the elongated arm further configured to position the looped end in alignment with the hook such that the hook can thread into the looped end when the head is rotated relative to the elongated arm, the clip configured to permit the arm to rotate relative to the elongated handle.
